(19) United States
(12) Patent Application Publication
(10) Pub. No.: US 2013/0099420 A1
(43) Pub. Date: Apr. 25, 2013

(54) PICKING TOOL

(71) Applicant: Gerry Ha, Vaughan (CA)

(72) Inventor: Gerry Ha, Vaughan (CA)

(21) Appl. No.: 13/699,629

(22) PCT Filed: Jun. 2, 2011
(86) PCT No.: PCT/CA11/50333

§ 371 Date: Nov. 22, 2012

Related U.S. Application Data
(60) Provisional application No. 61/361,462, filed on Jul. 5, 2010.

(51) Int. Cl. B29C 45/40

(52) U.S. Cl. CPC B29C 45/4005
USPC 264/328.1; 425/556

(57) ABSTRACT

Disclosed herein is, amongst other things, a picking tool (200, 300) for use in a post-mold picking device (132) of an injection molding system (100) and a related method of post-mold handling a molded article (10) therewith. The picking tool (200, 300) includes a picker (240, 340) that is configured to pick, in use, a molded article (10) from a holder (130), wherein the picker (240, 340) includes: a flow director (244, 344) that is selectively operable, in use, to direct a flow of air into, or out of an interior of the molded article (10); and a sealing element (248, 348) that is sealable, in use, to an open end (11) of the molded article (10), responsive to evacuation of the interior of the molded article (10), and wherein the sealing element (248, 348) is selectively positionable, in use, relative to the open end of the molded article (10), between a picking position and a clearance position.

### TECHNICAL FIELD

The non-limiting embodiments disclosed herein generally relate to an injection molding system, and more particularly to a picking tool for use with a post-mold device, and a related method for use thereof.

### BACKGROUND

U.S. Pat. No. 5,688,008 to HANSCH, published on Nov. 18, 1997 discloses, amongst other things, a suction device for gripping an article has a sucker with a suction lip. The sucker is movable between inner and outer positions in the inlet end of a suction line and can be moved angularly. A reset element moves the sucker to its outer position. In the inner position, the sucker forms a sealing connection with the inlet end. In its outer position, leakage air flow can pass around the outside of the sucker and into the suction line. When the sucker is in its outer position and the suction lip is closed by an article to be gripped, a pre-depression of pressure less than the maximum suction is caused because of the leakage flow. As the result of that pre-depression, the sucker is moved to its inner position, causing a sealing connection between the sucker and the inlet end of the suction line. The depression is then increased, increasing the suction grip on the article.

U.S. Pat. No. 6,171,541 to NETER et al., published on Jan. 9, 2001 discloses, amongst other things, an improved method and apparatus for injection molding and cooling molded articles such as preforms so as to avoid crystallinity. The apparatus and method make use of a take-off plate for removing articles from a mold, which plate may include heat transfer devices for cooling exterior surfaces of the molded articles or preforms, and a system for cooling in a controlled manner interior surfaces of the molded articles or preforms.

U.S. Pat. No. 7,104,780 to DOMODOSSOLA et al., published on Sep. 12, 2006 discloses, amongst other things, a platen-mounted, post-mold cooling apparatus and method includes structure and/or steps for handling molded parts in an injection molding machine having a fixed platen, a moving platen, a core half, and a cavity half. A take off device coupled to the fixed platen is configured to remove molded parts from either the core half or the cavity half. A cooling device coupled to the moving platen is configured to cool the molded parts carried by the take off device. Preferably, the take off device extracts the just molded parts from the mold's core half and then moves linearly outboard of the mold halves. The subsequent movement of the moving platen to close the mold in the next molding cycle causes the cooling device's pins to engage the molded parts in the take off device part carriers. When the moving platen opens again, the molded parts are extracted from the part carriers by the cooling device pins. When the moving platen is fully open, the cooling device is rotated to eject the cooled parts from the machine.

U.S. Pat. No. 7,591,975 to KINTZINGER et al., published on Sep. 22, 2009 discloses, amongst other things, a molded article picker for a post-mold device and a related method for the use of the molded article picker for handling a molded article. The molded article picker includes a floating element being configured to be movable between an extended position and a retracted position and biased in the extended position. Furthermore, the molded article picker comprises a pressure structure extending through the floating element. The floating element is cooperable with the molded article to define a substantially enclosed volume including the pressure structure. The pressure structure is configured such that by evacuating the substantially enclosed volume the molded article is sealed to the floating element and the floating element is drawn into the retracted position, thereby transferring the molded article to the molded article picker.

US Patent Application Publication 2004/0047940 to ZOPPAS, published on Mar. 11, 2004 discloses, amongst other things, a pick-up plug for supporting and transporting preforms of thermoplastic resin, comprising a central body, engagement means adapted to slip into the neck portion of the preform, in which elastic members are provided on said means so as to press them against the wall of said neck portion, wherein said central body is provided with at least three groove-like recesses opening towards the exterior and said engagement means are constituted by individual and independent gripping members that are housed in respective ones of said groove-like recesses; said elastic members are constituted by respective preloaded springs acting between the inner wall of each groove-like recess and the inner wall of the respective individual gripping member. The groove-like recesses are provided with a respective niche adapted to be engaged by a terminal portion of a respective one of said individual and independent gripping members, so that the latter are capable of rotating with the respective terminal portion pivotally retained in the respective one of said niches.

US Patent Application Publication 2006/0138696 to WEINMANN, published on Jun. 29, 2006 discloses, amongst other things, a method and a device for the secondary treatment and the cooling of preforms once they have been removed from the open mould halves of an injection moulding machine. The preforms are removed from the open moulds while still hot, by means of water-cooled cooling sleeves of a removal device, and are subjected to intensive cooling during the duration of an injection moulding cycle. Both the entire inner side and the entire outer side of the blow-moulded part are subjected to intensive cooling. Secondary cooling is then carried out, the duration thereof being equal to a multiple of the duration of an injection moulding cycle. After being removed from the casting moulds, the preforms are dynamically introduced into the cooling sleeves until they fully touch the walls thereof. The inner cooling is carried out in a time-delayed manner.

US Patent Application Publication 2009/0212459 to NETER et al., published on Aug. 27, 2009 discloses, amongst other things, a system for the post-treatment of preforms produced in an injection molding mold, comprising at least two post-treatment tools which each have a receiving plate which has a group of receiving cavities and a pin plate which has a group of post-treatment pins, and a device for transferring the preforms from the injection molding mold alternately into the at least two post-treatment tools. In order to provide a method of and a system for the post-treatment of preforms produced in an injection molding mold, which on the one hand allows early removal of the preform from the injection molding tool and which on the other hand allows reliable post-treatment in particular of the interior of the preform after removal from the injection molding mold, it is proposed in accordance with the invention that the post-treatment pins remain in the preforms for a period of time which is longer than the mold stand time.

US Patent Application Publication 2010/0001439 to BOCK., published on Jan. 7, 2010 discloses, amongst other things, a An auxiliary device and a method for finishing and calibrating preforms that are removed from a multiple tool in an unstable shape, the calibration process being performed with compressed air immediately after removing and withdrawing the preforms from the multiple tool. Nipples that can be inserted into the preforms are provided with expandable press rings or sealing rings in order to seal the interior of the blow-molded part of the preforms. The compressed air is introduced via the nipples, the sealing process being performed by radially expanding the press rings or sealing rings in analogy to the closing process of thermoses, thus protecting the preforms from adverse forces. The sealing point can be randomly selected in the transition zone from the threaded part to the blow-molded part of the preforms. The interior of the blow-molded part is optimally sealed without affecting the form stability and dimensional stability of the preforms.

US Patent Application Publication 2010/0013125 to BOCK., published on Jan. 21, 2010 discloses, amongst other things, a device and a method for finishing and calibrating preforms which are removed from a multiple injection tool in an unstable shape, and proposes an air cooler integrated into the water cooled cooling sleeves for the outer side of the open end face of the preform. Particularly in the case of special preform varieties, the areas which are unsupported in the cooling sleeves can be pre-strengthened on the outside, from the beginning of the transfer from the open molds to the removing and cooling sleeves, respectively, by means of a cooling which uses cooling air or low-temperature air. With the novel solution, the highest quality can be assured, in particular with respect to dimensional stability and the absence of pressure points under load, by means of a calibration in the cooling sleeves and the treatment in the area of the aftercooling.

EP Patent 1123189-B1 to BOCK., published on Jan. 21, 2010 discloses, amongst other things, an invention the aim of which is to improve the cooling or subsequent cooling range during the production of pre-shaped bodies for PET bottles, so-called preforms. Water cooling is primarily used for initial cooling and also during subsequent cooling. The air action, however, is improved by assigning mechanically displaceable elements to the air side action. As a result, the security with regard to malfunctions during handling as well as the cooling action can be improved. When combined, two especially advantageous embodiments yield an optimal solution. A valve-like element is provided for ejecting and an air nozzle is provided for the interior of the preforms, said nozzle assisting in the handling and cooling.

### SUMMARY

According to a first aspect claimed herein, there is provided a picking tool for use in a post-mold picking device of an injection molding system and a related method of post-mold handling a molded article therewith. The picking tool includes a picker that is configured to pick, in use, a molded article from a holder, wherein the picker includes: a flow director that is selectively operable, in use, to direct a flow of air into, or out of, an interior of the molded article; and a sealing element that is sealable, in use, to an open end of the molded article, responsive to evacuation of the interior of the molded article, and wherein the sealing element is selectively positionable, in use, relative to the open end of the molded article, between a picking position and a clearance position.

According to a second aspect claimed herein, there is provided a method of post-mold handling a molded article in an injection molding system having a post-mold retrieval device and a post-mold picking device, the method being executable at a controller that is connected to one or more system actuators. The method begins with releasing an insertion control signal to cause relative motion between a retrieval tool and a picking tool that are associated with the post-mold retrieval device and the post-mold picking device, respectively, whereby a flow director that is associated with a picker on the picking tool is inserted within an interior of a molded article that is being held by a holder that is associated with the retrieval tool. Next, the method includes releasing a retraction control signal to cause a positioner that is associated with the picking tool to retract a sealing element that is associated with the picker into a clearance position, whereby a gap is provided between the sealing element and an open end of the molded article through which air is passable. Next, the method includes releasing a conditioning control signal to cause the flow director to promote circulation of air within the interior of the molded article. Next, the method includes releasing an extension control signal to cause the positioner to extend, whereby the sealing element becomes extensible towards a picking position for sealably contacting the molded article. The method ends with releasing an evacuation control signal to cause an evacuation of air, through the flow director, from within the interior of the molded article, and responsive thereto cause the molded article to seal with the sealing element.

These and other aspects and features will now become apparent to those skilled in the art upon review of the following description of specific non-limiting embodiments in conjunction with the accompanying drawings.

### DETAILED DESCRIPTION OF THE DRAWINGS

The detailed description of illustrative (non-limiting) embodiments will be more fully appreciated when taken in conjunction with the accompanying drawings, in which:

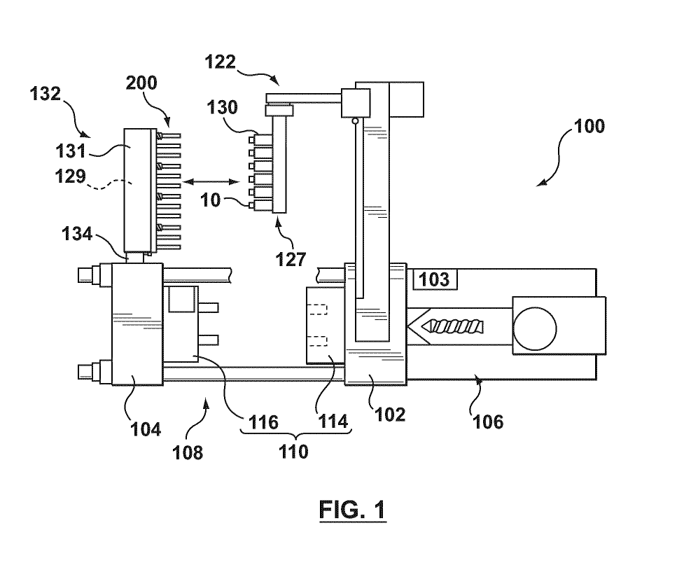

FIG. 1 depicts a schematic representation of an injection molding system 100, according to a non-limiting embodiment thereof;

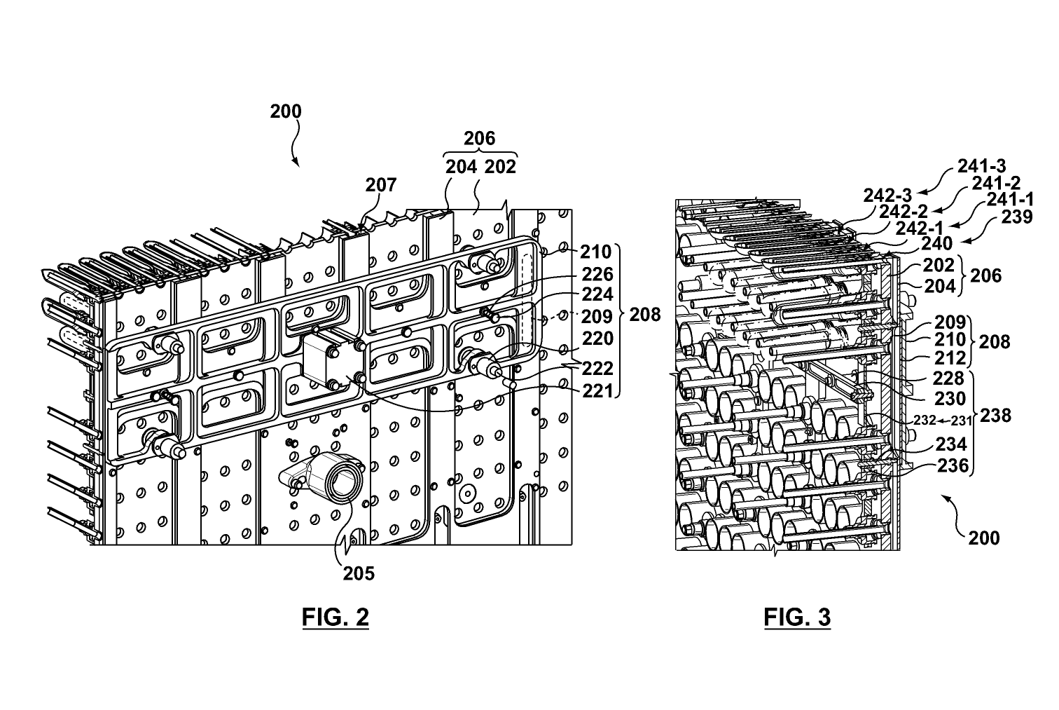

FIG. 2 depicts a rear perspective view of a portion a picking tool, according to a non-limiting embodiment thereof, for use with a post-mold picking device of the injection molding system of FIG. 1;

FIG. 3 depicts a front perspective view of the portion of the picking tool of FIG. 2;

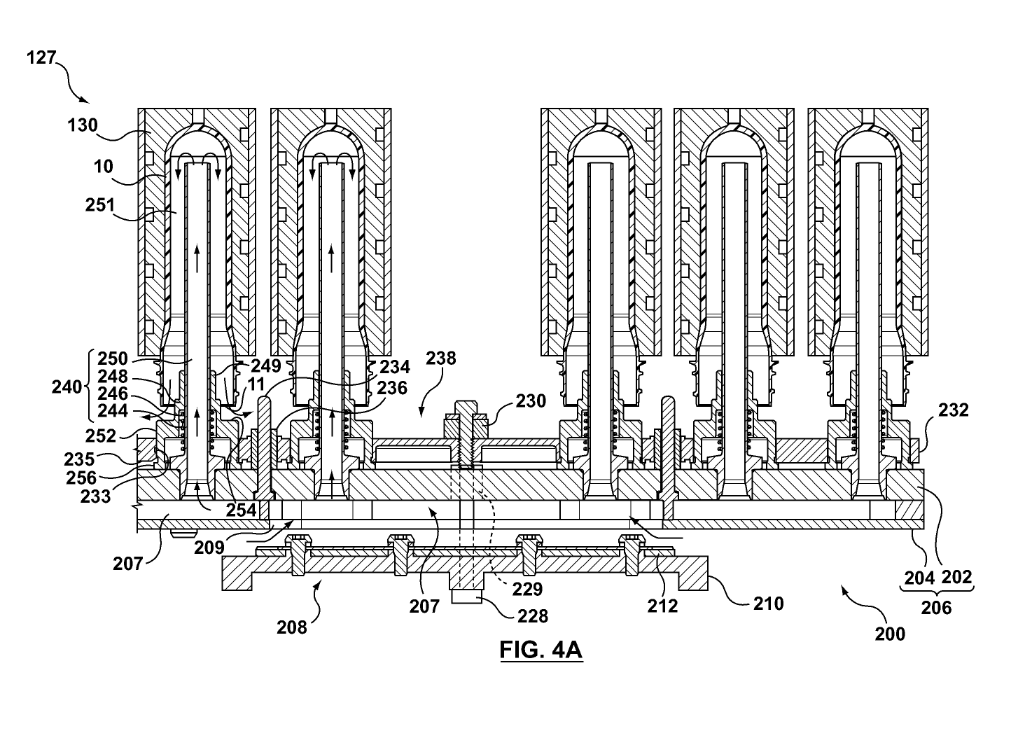

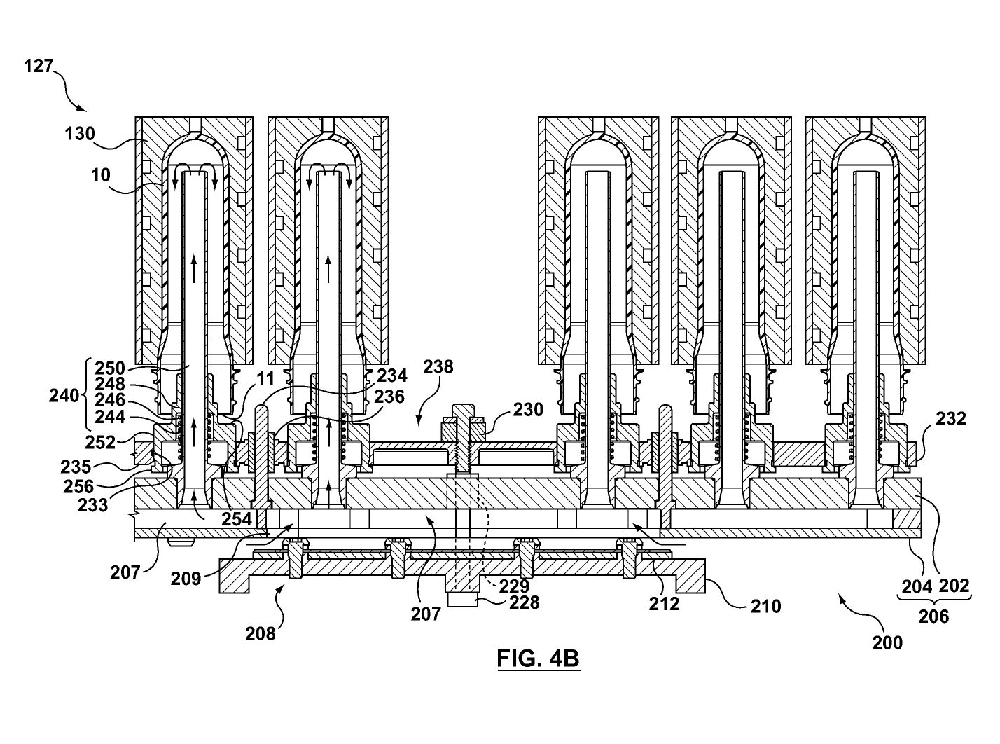

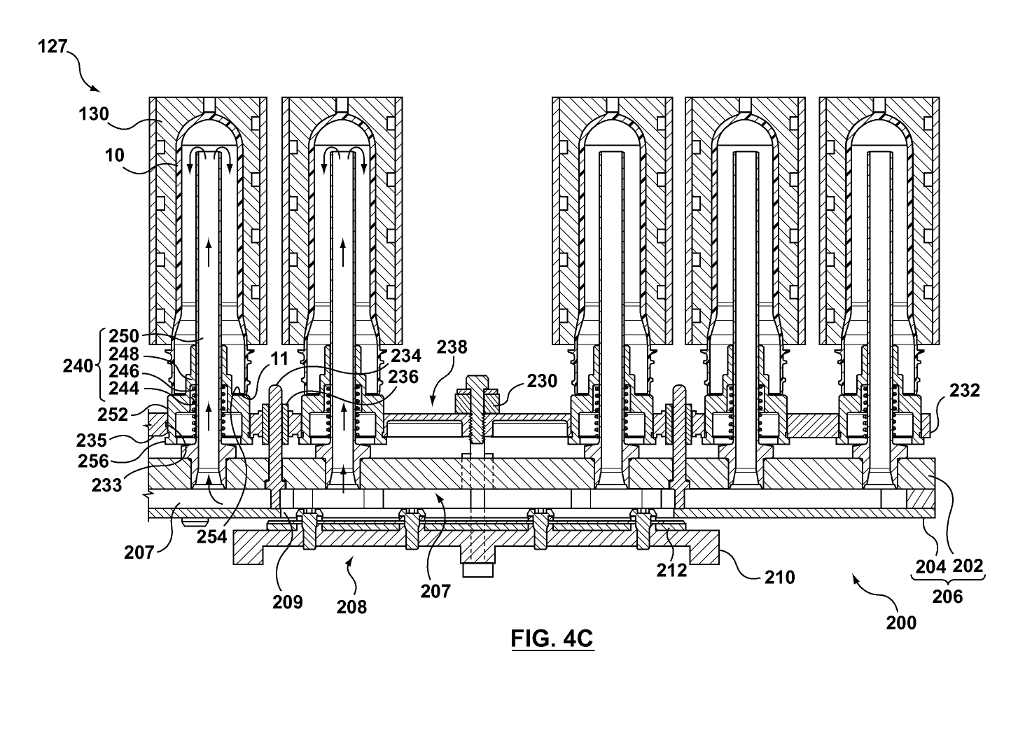

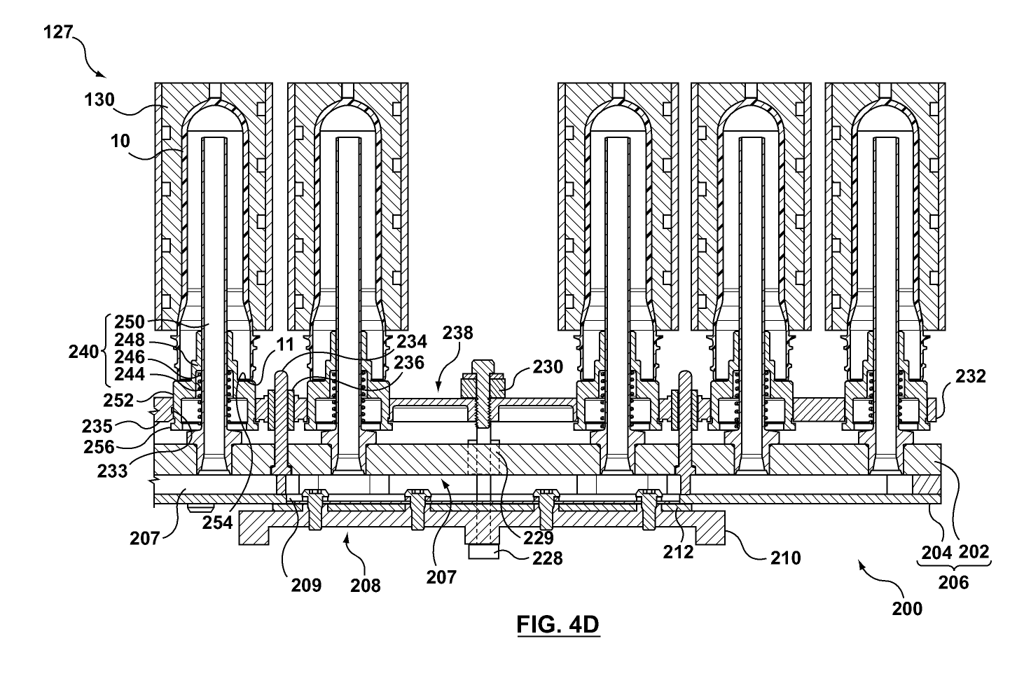

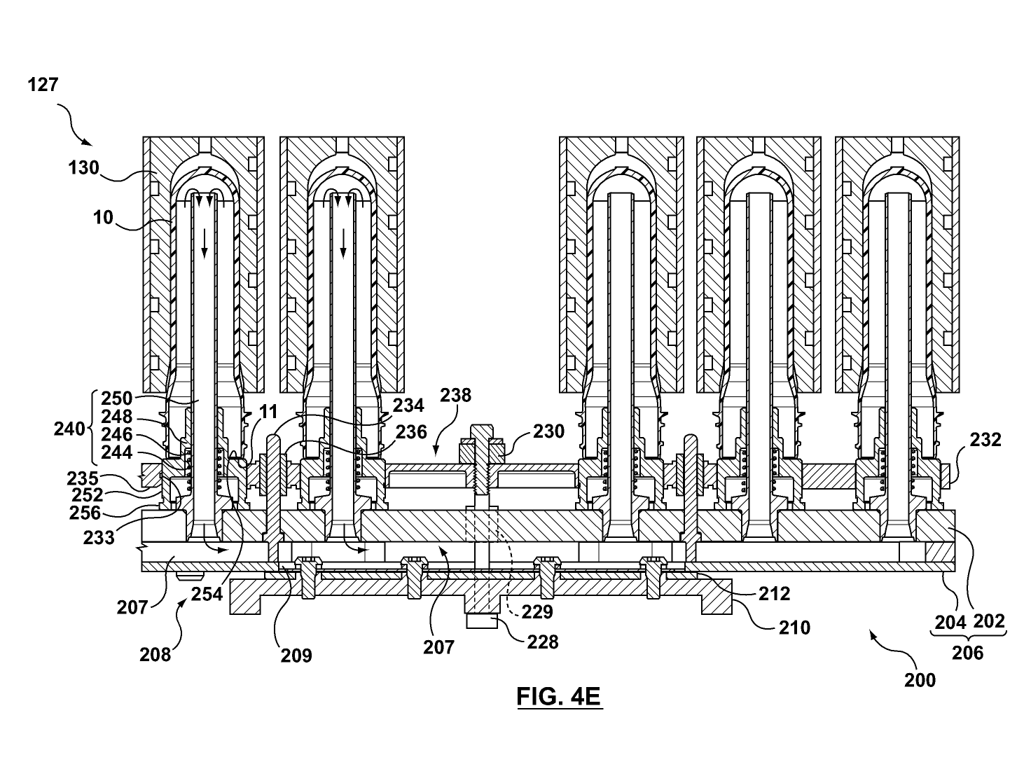

FIG. 4A depicts section views of the picking tool of FIG. 2 and of holders within which molded articles are being held, at a first point in an operational sequence of the picking tool;

FIG. 4B depicts similar section views to those of FIG. 4A at a second point in the operational sequence of the picking tool;

FIG. 4C depicts similar section views to those of FIG. 4A at a third point in the operational sequence of the picking tool;

FIG. 4D depicts similar section views to those of FIG. 4A at a fourth point in the operational sequence of the picking tool;

FIG. 4E depicts similar section views to those of FIG. 4A at a fifth point in the operational sequence of the picking tool;

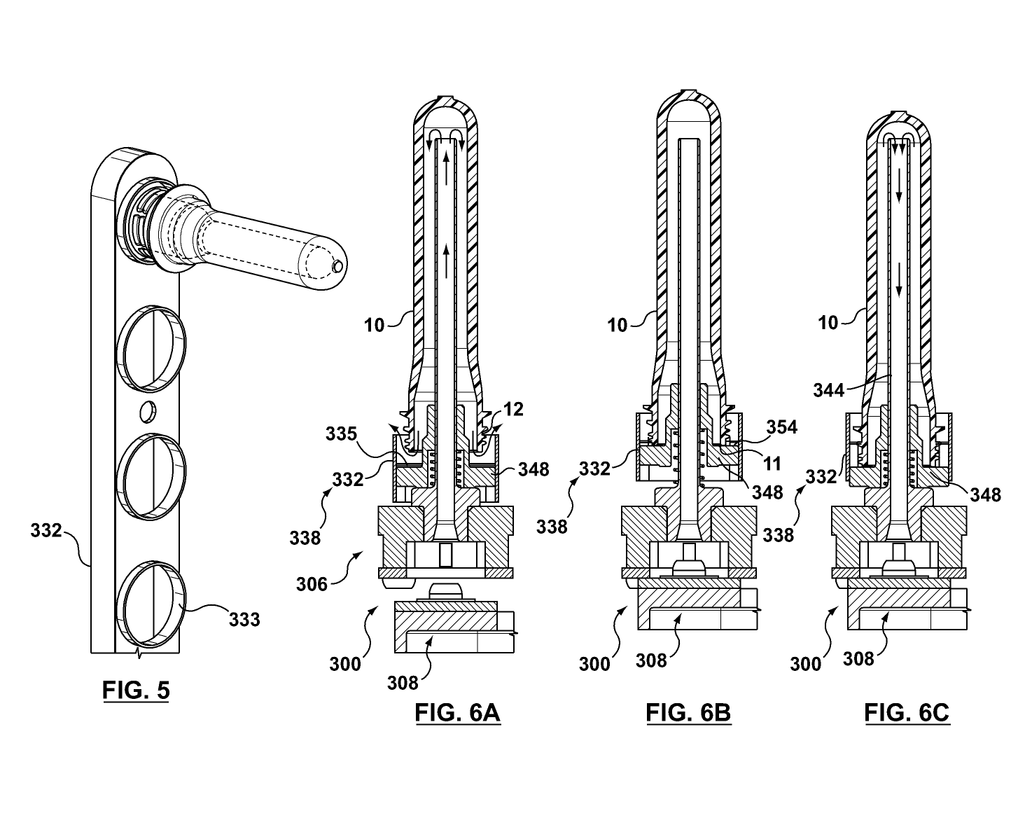

FIG. 5 is a perspective view of an engager, according to another non-limiting embodiment thereof, for use in a positioner of a picking tool;

FIG. 6A depicts section views of a picking tool, according to another non-limiting embodiment thereof, and of the holder within which the molded article is being held, at a first point in an operational sequence of the picking tool, wherein the picking tool includes the positioner having the engager of FIG. 5;

FIG. 6B depicts similar section views to those of FIG. 6A at a second point in the operational sequence of the picking tool;

FIG. 6C depicts similar section views to those of FIG. 6A at a third point in the operational sequence of the picking tool;

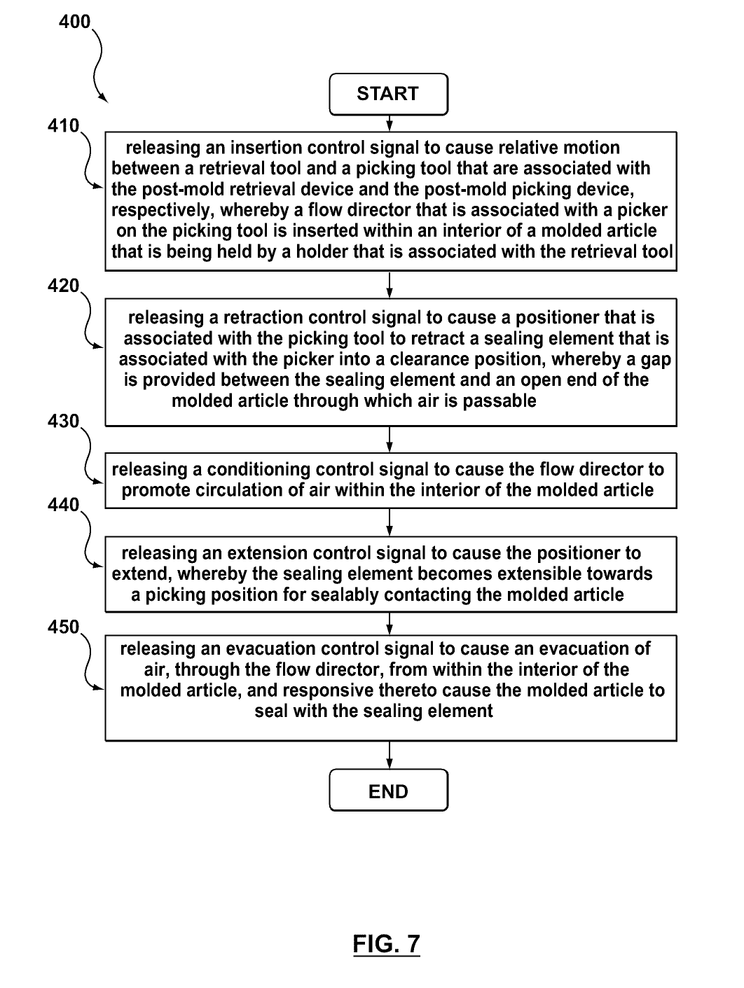

FIG. 7 depicts a flow-chart of a method of post-mold handling a molded article in the injection molding system of FIG. 1.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION OF THE NON-LIMITING EMBODIMENT(S)

FIG. 1 is a schematic representation of an injection molding system 100, according to a non-limiting embodiment thereof. The injection molding system 100 broadly includes an injection unit 106, a clamp unit 108, a post-mold retrieval device 122, and a post-mold picking device 132. The injection molding system 100 also includes an injection mold 110, wherein a first mold half 114 and a second mold half 116 thereof are mounted to a stationary platen 102 and a moving platen 104 of the clamp unit 108, respectively.

In general, the structure and operation of the injection molding system 100 is consistent with that known to those of skill in the art. As such, a detailed description of the injection molding system 100 has been omitted herein; however, a description of a similar injection molding system may be referenced, for example, in the description of U.S. Pat. No. 7,104,780, as summarized hereinbefore.

The injection molding system 100 is shown with the injection mold 110 in a mold-open configuration for sake of permitting a retrieval tool 127, which is mounted to the post-mold retrieval device 122, access in between the first and second mold halves 114, 116 to retrieve molded articles 10 from the second mold half 116. The so-retrieved molded articles 10 are shown to be held within multiple arrays of interlaced holders, included in which is a holder 130, that are associated with the retrieval tool 127.

The post-mold picking device 132 includes a plenum box 131, a picker tool 200, and a rotatable mount 134. The picker tool 200 includes an array of pickers and several arrays of nozzles that are interlaced therewith. The picker tool 200 is mounted to the plenum box 131 to enclose a plenum 129 that is defined therein. A blower, not shown, or some other form of pressure source (i.e. supply of air) or sink (i.e. vacuum), is associated with the plenum 129 for moving air, in use, through the array of pickers and the arrays of nozzles that are associated with the picker tool 200. The rotatable mount 134 connects the plenum box 131 with the moving platen for movement, in use, therewith. In addition, the rotatable mount provides for rotation of the plenum box 131, and with it the picking tool 200, between a picking orientation (e.g. vertical) and an ejection orientation (e.g. horizontal).

In operation, as is known in the art, with the picking tool 200 in the picking orientation (FIG. 4A) and with subsequent rearrangement of the moving platen 104 relative to the stationary platen 102, to rearrange the injection mold 110 into a mold-closed configuration, not shown, the array of pickers and the arrays of nozzles are positioned within the molded articles that are being held in the multiple arrays of holders on the retrieval tool 127. Thereafter, the array of pickers may be operated to pick their respective molded articles 10 while the arrays of nozzles are operated to condition their respective molded articles 10 with the dispensing of air, or some other fluid, therein. With a subsequent rearrangement of the moving platen 104 relative to the stationary platen 102, to rearrange the injection mold 110 into the mold-open configuration, as shown, the array of pickers extract molded articles therewith. Lastly, the picking tool 200 is rotated to the ejection orientation, not shown, for deposit of the molded articles, with the ejection thereof from the array of pickers, after which the picking tool 200 is once again returned to the transfer position to begin yet another cycle.

It is known to configure the array of pickers in keeping with the teachings of U.S. Pat. No. 7,591,975, as summarized hereinbefore. Despite having provided a robust and reliable means for picking molded articles 10 from their holders 130, such pickers have never been structured for selective retraction of the sealing element therein without the molded article being sealed thereto. It has now been recognized that by providing a positioner in association with the tooling plate, such as, for example, a linear actuator (e.g. pneumatic actuator, servo motor, and the like), and wherein the positioner is linked to the sealing element for a selective positioning thereof, that this will allow for instituting an operational sequence wherein the sealing element may be selectively positioned between a picking position and a clearance position to provide a gap with respect to an open end 11 (FIG. 4A) of the molded article 10 through which air is passable. That is, it is now possible to operate the picker to both condition (e.g. heat or cool—most often cool) the molded article 10, for a time, before it is picked. Other uses for such a positioner are of course possible, as may be apparent to those of skill in the art.

Reference may now be made to FIGS. 2 and 3 wherein there is depicted a rear and front, perspective view, respectively, of a portion a picking tool 200, according to a non-limiting embodiment thereof.

The picking tool 200 includes a picker carrier 206 that is configured to support the array of pickers 239 thereon. The picking tool 200 also includes multiple arrays of nozzles that are also supported on the picker carrier 206, that include a first array of nozzles 241-1, a second array of nozzles 241-2, and a third array of nozzles 241-3, wherein the multiple arrays of nozzles are interlaced with the array of pickers 239. It should however be understood that the picking tool may be alternatively configured with a different number of arrays of nozzles, or without nozzles at all. The picker carrier 206 includes a tooling plate 202 having a manifold 204 mounted thereto. The array of pickers 239, the first array of nozzles 241-1, the second array of nozzles 241-2, and the third array of nozzles 241-3 are all supported on the tooling plate 202. A duct 207 is provided in a space that is defined between the manifold 204 and a back face of the tooling plate 202. The duct 207 is alternately connectable, in use, to a source or sink or air, as will be explained later, to either dispense or evacuate air through the array of pickers 239.

It may also be appreciated that the duct 207 includes a pressure port 209, shown in a hidden outline behind a valve plate 210, through which the duct 207 may be selectively connectable, in use, to the plenum 129 (FIG. 1). The duct 207 also includes a vacuum port 205 that is selectively connectable, in use, to a pressure sink (i.e. vacuum source), and wherein the duct 207 fluidly connects each of the pressure port 209 and the vacuum port 205 to the array of pickers 239.

The picking tool 200 also includes a valve 208 at the pressure port 209 with which to selectively seal the pressure port 209. More particularly, the valve 208 includes a valve plate 210 that is movably connected to the picker carrier 206. In operation, the valve plate 210 may be moved to a closed position (FIG. 4D) to seal the pressure port 209, thereby isolating the duct 207 from the plenum 129 (FIG. 1). Likewise, the valve plate 210 may be moved to an open position (FIG. 4A) to open the pressure port 209, thereby fluidly connecting the duct 207 to the plenum 129 (FIG. 1). The valve plate 210 may include a gasket 212 mounted thereto with which to deformably seal, in use, with the pressure port 209. Alternatively, the gasket 212 may be omitted wherein instead the seal is provided between closely fitted surfaces of the manifold 204 and the valve plate 210, such as those made from metal or a hard plastic. The valve 208 also includes an actuator 221 (e.g. pneumatic, servo-electric linear actuator, or other such device) with which to position the valve plate 210. To simplify movement control of the valve plate 210, the valve 208 may also include a further biasing element 226 to bias the valve plate 210 towards the closed position, whereby the actuator need only be configured as a single acting actuator, although a dual acting actuator may be a suitable alternative.

FIG. 4A depicts section views of the picking tool 200 and of a row of holders 130 within which molded articles 10 are being held at a first point in the operation of the picking tool 200. More particularly, the view reveals a row of pickers 240, of the array of pickers 239, as they are being operated to condition the molded articles that are being held in the row of holders 130.

From this view it may be appreciated that each picker 240 includes a flow director 244 that is configured to be inserted, in use, within an interior of a molded article 10 with relative movement of the picking tool 200 and the retrieval tool 127 as explained previously. The flow director 244 is configured to be positioned, in use, within the interior of the molded article 10 such that an annular channel 251 is defined therebetween. As shown, the flow director 244 may have a tubular structure wherein a pressure channel 250 that passes through the tubular structure is used to fluidly connect the annular channel 251 with the duct 207 that is associated with the picking tool 200.

The picker 240 also includes a sealing element 248 that is sealable, in use, to an open end 11 of the molded article 10. The sealing element 248 and the flow director 244 are configured to cooperate wherein the sealing element 248 is sealingly slidable along a portion of the flow director 244.

The sealing element 248 may have, for example, an annular structure having a sealing face 254 thereon with which to seal, in use, with the open end 11 of the molded article 10. The seal therebetween does not need to be air tight. In fact, in the present non-limiting embodiment, the sealing element 248 is made from a hard plastic and as such the sealing face 254 is unable to deform sufficiently to make perfect seal with the open end 11 of the molded article 10. In accordance with another non-limiting embodiment of the picker, not shown, a seal gasket, not shown, may be associated with the sealing element 248, wherein the seal gasket is deformable to provide a relatively air tight seal, in use, with the open end 11 of the molded article 10.

The annular structure of the sealing element 248 may also define a guide portion 249 that is configured to guide the sealing element 248 along the outer surface of the tubular structure of the flow director 244.

Lastly, the picker 240 may include, as shown, a biasing element 246 that is disposed between the flow director 244 and the sealing element 248 with which to bias the sealing element 248 to extend, relative to the flow director 244, towards a picking position. In accordance with an alternative non-limiting embodiment, not shown, the biasing element 246 may be arranged to bias the sealing element 248 to retract to a clearance position.

As alluded to previously, the picking tool 200 also includes a positioner 238 that is configured to selectively position the sealing element 248 between the picking position and the clearance position. A technical effect of which may include the possibility to selectively position the sealing element 248 to provide a gap between the sealing face 254 thereon and the open end 11 of the molded article 10, whereby air may be dispensed, as indicated by the flow arrows, through the interior of the molded article 10 for sake of a conditioning (i.e. cooling or heating) thereof. While the flow arrows indicate that overpressure in the duct 207 forces air to pass from the aperture of the flow director 244 and out the open end 11 of the molded article 10, it is equally possible to reverse the flow by evacuating air, not shown, through the duct 207.

The positioner 238 includes an engager 232 that is movably connected to the picker carrier 206, wherein the engager 232 is configured to engage the sealing element 248 with motion thereof from an extended position towards a retracted position, whereby the sealing element 248 is retracted therewith. In FIG. 4A the positioner 238 is depicted in the retracted position, and as such the sealing element 248 has been positioned into its clearance position. More particularly, the engager 232 has a rail structure that defines a cylindrical opening, or more particularly a series thereof, within which the sealing element 248 is slidably arranged. The rail structure of the engager 232 also defines an engagement face 235 that is configured to engage a flange 256 on the sealing element 248. The engager 232 is also configured to be disengageable from the sealing element 248 with movement of the engager 232 towards an extended position (FIG. 4D), whereby the sealing element 248 may be retracted relative thereto (FIG. 4E).

Briefly, in accordance with another non-limiting embodiment, not shown, wherein the biasing element 246 may be arranged to bias the sealing element 248 to retract to the clearance position, as previously mentioned, the positioner 238 would instead be configured to engage the sealing element 248 with motion thereof from the retracted position to the extended position.

Returning now to the description of the non-limiting embodiment of the picking tool 200, as shown with reference to FIG. 3, it may be further appreciated that the positioner 238 includes a plurality of engagers 231, included in which is the engager 232, each of which is configured to engage, in use, with a subset (e.g. a column) of the array of pickers 239. The positioner 238 may be connected to the valve 208 for coordinated movement, in use, thereof. As such, the positioner also includes a connecting bar 230, wherein the plurality of engagers 231 are linked together therewith. Furthermore, as also shown in FIG. 4A, the positioner 238 also includes a connecting rod 228, such as, for example, a bolt, with which to connect the connecting bar 230 with the valve plate 210. A bushing 229 is associated with the tooling plate 202 to guide movement of the connecting rod 228. To further guide the movement of each engager 232 a pair of bushings 236 may be mounted thereto that cooperate, in use, with a pair of guide pins 234 that are associated with the tooling plate 202.

The operation of the picking tool 200 will now be briefly described with reference to the operational sequence that is depicted in FIGS. 4A through 4E.

With reference to FIG. 4A, the picking tool 200 is depicted at a first point in the operational sequence thereof, wherein the picking tool 200 performs the step of conditioning the molded articles 10 as they are being held in the holders 130, a direction of the air flow being denoted with flow arrows. The step of conditioning the molded articles 10 in this manner is typically performed, for a time, with closing, or just after closing, of the injection mold 110 (FIG. 1) and thus insertion of the flow directors 244 into their respective molded articles 10. To perform this function, the valve 208 is arranged in the open position to connect the duct 207 to the plenum 129 (FIG. 1) and thereby connect the flow directors 244 to a supply of air. In addition, the positioner 238 is arranged in the retracted position whereby the sealing elements 248 have been positioned into their clearance positions to provide the gap between the sealing face 254 thereon and the open end 11 of the molded article 10 such that the flow of air is passable therethrough.

With reference to FIG. 4B, the picking tool 200 is depicted at a second point in the operational sequence thereof, wherein as the picking tool 200 has undergone an initial stage of transition to being operable to pick the molded articles 10 from their holders 130. As such, the positioner 238 is shown to be partially extended, on its way to the extended position, the sealing element 248 having extended therewith, under the influence of the biasing element 246, and wherein a gap remains, albeit narrower, between the sealing face 254 thereon and the open end 11 of the molded article 10 such that the flow is sustained therethrough. The valve 208, which is linked to the positioner 238, has also been partially extended, on its way to the closed position, however the duct 207 remains connected to the plenum 129 (FIG. 1) and as such air continues to be supplied to the flow directors 244.

With reference to FIG. 4C, the picking tool 200 is depicted at a third point in the operational sequence thereof, wherein as the picking tool 200 is further along in its transition to being operable to pick the molded articles 10 from their holders 130. As such, the positioner 238 is shown to have extended sufficiently to permit the sealing element 248 to move to its picking position and thus make contact with the open end 11 of the molded article 10 such that there is no longer any possibility of air flow therebetween. The valve 208, which is linked to the positioner 238, has also been further extended, on its way to the closed position, and wherein the duct 207 is now barely connected to the plenum 129 (FIG. 1).

With reference to FIG. 4D, the picking tool 200 is depicted at a fourth point in the operational sequence thereof, wherein as the picking tool 200 is nearing the end of its transition to being operable to pick the molded articles 10 from their holders 130. As such, the positioner 238 is shown to have reached its extended position, wherein it has moved a small distance relative to the sealing element 248 that remained motionless having previously contacted with the open end 11 of the molded article 10. A technical effect of the foregoing may include the ability to seal all of the sealing elements 248 to the open ends 11 of their respective molded articles 10 even where a misalignment between the picking tool 200 and the retrieval tool 127 (FIG. 1) may otherwise have prevented initial contact between them at the third point in the operational sequence. In preparation for picking the molded article 10, the valve 208, which is linked to the positioner 238, is now in the closed position, and wherein the duct 207 is now fluidly disconnected from the plenum 129 (FIG. 1).

With reference to FIG. 4E, the picking tool 200 is depicted at a fifth point in the operational sequence thereof, wherein as the picking tool 200 has now successfully picked the molded articles 10 from their holders 130. As such, with the positioner 238 remaining it its extended position, the duct 207 has been connected to the vacuum port 205, whereby air is evacuated from the enclosed space that is defined between the flow directors 244 and the interior of the molded articles 10, the direction of the air flow being denoted with flow arrows, and in so doing cause the sealing elements 248, and the molded article sealed thereto, to retract relative to their holders 130. In tandem, the holder 130 may also assist with the ejection of the molded article 10 therefrom, such as with application of overpressure therein through a port that is defined in the base thereof.

With the molded articles 10 having been picked from their holders 130, the picking tool 200 may next be moved away from the retrieval tool 127 (FIG. 1), as explained previously, after which point the picking tool 200 may be rotated, not shown, to eject the molded articles 10 with opening of the valve 208.

Reference will now be made to FIG. 5 that depicts a perspective view of another embodiment of an engager 332 for use in the positioner 238 (FIG. 3) or with a positioner 338 of another non-limiting embodiment of a picking tool 300 as shown in FIGS. 6A, 6B and 6C.

The engager 332 has a rail structure that defines a series of cylindrical openings through a top panel thereof within which the sealing element 348 may be slidably arranged. The engager 332 also defines a flow deflector 333 around each of the cylindrical openings, in the form of an annular projection from the top panel. The flow deflectors are configured to deflect, in use, the flow of air exiting from the open end 11 of the molded article 10, along an outer portion of the molded article 10, as shown with reference to FIG. 6A, a technical effect of which may include a conditioning of an outer portion of the molded article 10.

With reference to FIG. 6A it may also be appreciated that the engager 332 defines an engagement face 335 with which to engage an outer annulus of the sealing face 354 on the sealing element 348. The engagement face 335 includes a complimentary annulus that is defined on a back face of the top panel surrounding each of the cylindrical openings. Where the sealing element 348 is provided with a semi-cylindrical shape (i.e. the sides thereof are flat) the portion of the sealing face 354 that is engaged by the engagement face 335 may be reduced to a pair of diametrically opposed crescent shaped portions.

The operation of the picking tool 300 will now be briefly described. In FIG. 6A, the picking tool 300 is depicted at a first point in the operational sequence thereof (which, for sake of contrast, correlates to the first point in the operational sequence of the picking tool 200 shown in FIG. 4A), wherein the picking tool 300 performs the step of conditioning the molded article 10 as it is being held in the holder 130, a direction of the air flow being denoted with flow arrows. To perform this function, the valve 308 is arranged in the open position. In addition, the positioner 338, including the engager 332, is arranged in the retracted position whereby the sealing element 348 is held in its clearance position through cooperation of the engagement face 335, on the engager 332, with the sealing face 354, on the sealing element 348, to provide a gap between the sealing face 354 thereon and the open end 11 of the molded article 10 such that the flow of air is passable therethrough.

With reference to FIG. 6B, the picking tool 300 is depicted at a second point in the operational sequence thereof (which, for sake of contrast, correlates to the fourth point in the operational sequence of the picking tool 200 shown in FIG. 4D), wherein as the picking tool 300 is nearing the end of its transition to being operable to pick the molded article 10 from the holder 130. As such, the positioner 338 is shown to have reached its extended position, and wherein the engager 332 has extended a small distance relative to the sealing element 348. That being said, it is not necessary in every instance to provide for the engager to extend relative to the engager 332 to provide for a good seal between the sealing face 354 of the sealing element 348 and the open end 11 of the molded article 10. In preparation for picking the molded article 10, the valve 308, which is linked to the positioner 338, is now in the closed position.

With reference to FIG. 6C, the picking tool 300 is depicted at a third point in the operational sequence thereof (which, for sake of contrast, correlates to the fifth point in the operational sequence of the picking tool 200 shown in FIG. 4E), wherein as the picking tool 300 has now successfully picked the molded article 10 from the holder 130. As such, with the positioner 338 remaining it its extended position, the air is evacuated from the enclosed space that is defined between the flow director 344 and the interior of the molded article 10, the direction of the air flow being denoted with flow arrows, and in so doing cause the sealing element 348, and the molded article sealed thereto, to retract relative to the holder 130.

Thus, having described several non-limiting embodiments of the picking tool 200, 300, a method 400 of post-mold handling a molded article 10 (FIG. 1) in the injection molding system 100 (FIG. 1) will now be described with reference to the flow chart of FIG. 8. The method is executable at a controller 103 (FIG. 1) that is connected to one or more system actuators, not shown, such as those that are associated with each of the injection unit 106, the clamp unit 108, the post-mold retrieval device 122, and the post-mold picking device 132.

The controller 103 can be implemented as a general-purpose or purpose-specific computing apparatus that is configured to control one or more operations of the injection unit 106. It is also noted that the controller 103 can be a shared controller that controls operation of an injection molding machine (not depicted) that houses the injection unit 106 and/or other auxiliary equipment (not depicted) associated therewith.

The method 400 begins with releasing 410 an insertion control signal to cause relative motion between the retrieval tool 127 and the picking tool 200, 300 that are associated with the post-mold retrieval device 122 and the post-mold picking device 132, respectively, whereby the flow director 244, 344 that is associated with the picker 240, 340 on the picking tool 200, 300 is inserted within the interior of the molded article 10 that is being held by the holder 130 that is associated with the retrieval tool 127.

Next, the method 400 includes releasing 420 a retraction control signal to cause the positioner 238, 338 that is associated with the picking tool 200, 300 to retract the sealing element 248, 348 that is associated with the picker 240, 340 into the clearance position, whereby a gap is provided between the sealing element 248, 348 and the open end 11 of the molded article 10 through which air is passable.

Next, the method 400 includes releasing 430 a conditioning control signal to cause the flow director 244, 344 to promote circulation of air within the interior of the molded article 10, as shown with reference to FIGS. 4A and 6A.

Next, the method 400 includes releasing 440 an extension control signal to cause the positioner 238, 338 to extend, whereby the sealing element 248, 348 becomes extensible towards the picking position for sealably contacting the molded article 10, as shown with reference to FIGS. 4D and 6B.

The method 500 may end with releasing 450 an evacuation control signal to cause an evacuation of air, through the flow director 244, 344, from within the interior of the molded article 10, and responsive thereto cause the molded article 10 to seal with the sealing element 248, 348.

The method 400 may also include additional steps, such as, releasing a removal control signal to cause relative separating motion between the retrieval tool 127 and the picking tool 200, 300, whereby the molded article 10 that is sealed to the picker 240, 340 is removed from the holder 130.

With the releasing the retraction control signal to cause the positioner 238, 338 to retract further causes a valve 208, 308 that is associated with the picking tool 200, 300 to connect the flow director 244, 344 with a plenum 129 that is operable to provide a supply of air thereto, whereby a dispensing of air within the interior of the molded article 10 provides for a conditioning thereof.

Similarly, with the releasing 430 the extension control to cause the positioner 238, 338 to extend further causes the valve 208, 308 to disconnect the flow director 244, 344 from the plenum 129, after which the duct 207 may be connected to a vacuum sink as explained hereinbefore.

Lastly, although not in any particular order, the method 400 may further include releasing an alignment control signal to cause a selected alignment between the retrieval tool 127 and the picking tool 200, 300, whereby the array of pickers 239 are aligned with a selected one of the multiple arrays of interlaced holders, and wherein the one or more arrays of nozzles are aligned with a remaining one or more of the multiple arrays of interlaced holders to direct air from the plenum 129 into the interior of molded articles that are being held therein.

It is noted that the foregoing has outlined some of the more pertinent non-limiting embodiments. These non-limiting embodiments may be used for many applications. Thus, although the description is made for particular arrangements and methods, the intent and concept of these non-limiting embodiments may be suitable and applicable to other arrangements and applications. It will be clear to those skilled in the art that modifications to the disclosed non-limiting embodiments can be effected. The described non-limiting embodiments ought to be construed to be merely illustrative of some of the more prominent features and applications thereof. Other beneficial results can be realized by applying these non-limiting embodiments in a different manner or modifying them in ways known to those familiar with the art. This includes the mixing and matching of features, elements and/or functions between various non-limiting embodiments is expressly contemplated herein, unless described otherwise, above.

1. A picking tool (200, 300) for use in a post-mold picking device (132) in an injection molding system (100), comprising:
a picker (240, 340) that is configured to pick, in use, a molded article (10) from a holder (130), wherein the picker (240, 340) includes: a flow director (244, 344) that is selectively operable, in use, to direct a flow of air into, or out of, an interior of the molded article (10);
a sealing element (248, 348) that is sealable, in use, to an open end (11) of the molded article (10), responsive to evacuation of the interior of the molded article (10), and wherein the sealing element (248, 348) is selectively positionable, in use, relative to the open end of the molded article (10), between a picking position and a clearance position; and
a positioner (238, 338) that is configured to selectively position the sealing element (248, 348).

2. The picking tool (200, 300) of claim 1, wherein:
the picker (240, 340) also includes a biasing element (246, 346), wherein the biasing element (246, 346) and the sealing element (248, 348) are configured to cooperate to bias the sealing element (248, 348) to extend.

3. The picking tool (200, 300) of claim 1, wherein:
the sealing element (248, 348) and the flow director (244, 344) are configured to cooperate wherein the sealing element (248, 348) is sealingly slidable along a portion of the flow director (244, 344).

4. The picking tool (200, 300) of claim 1, further comprising:
a picker carrier (206, 306) that is configured to support the picker (240, 340) and the positioner (238, 338) mounted thereto.

5. The picking tool (200, 300) of claim 4, wherein:
the positioner (238, 338) includes an engager (232, 332) that is movably connected to the picker carrier (206, 306), and wherein the engager (232, 332) is configured to engage the sealing element (248, 348) with motion thereof from an extended position towards a retracted position, whereby the sealing element (248, 348) is retracted therewith.

6. The picking tool (200, 300) of claim 5, wherein:
the engager (232, 332) is configured to be disengageable from the sealing element (248, 348) with movement of the engager (232, 332) towards the extended position, whereby the sealing element (248, 348) may be retracted relative thereto.

7. The picking tool (200, 300) of claim 5, wherein:
the engager (432) includes a flow deflector (433) with which to deflect the flow of air, in use, that is exiting from the open end (11) of the molded article (10), along an outer portion of the molded article (10).

8. The picking tool (200, 300) of claim 5, wherein:
the picker carrier (206, 306) is configured to mount, in use, to a plenum box (131) that defines a plenum (129) to provide, in use, a supply of air thereto.

9. The picking tool (200, 300) of claim 8, wherein:
a duct (207, 307) is associated with the picker carrier (206, 306), the duct (207, 307) includes a pressure port (209, 309) that is selectively connectable, in use, to the plenum (129), a vacuum port (205) that is selectively connectable, in use, to a vacuum source, and wherein the duct (207, 307) fluidly connects each of the pressure port (209, 309) and the vacuum port (205) to the flow director (244, 344).

10. The picking tool (200) of claim 9, wherein:
the picker carrier (206) includes a tooling plate (202) having a manifold (204) mounted thereto, and wherein the duct (207) is defined by the manifold (204).

11. The picking tool (200, 300) of claim 9, further comprising:
a valve (208, 308) at the pressure port (209, 309) with which to selectively seal, in use, the pressure port (209, 309).

12. The picking tool (200, 300) of claim 11, wherein:
the valve (208, 308) includes a valve plate (210, 310) that is movably connected to the picker carrier (206, 306), wherein the valve plate (210, 310) is configured to seal the pressure port (209, 309) when positioned, in use, in a closed position, and to open a connection between the pressure port (209, 309) and the plenum (129) when positioned, in use, in an open position.

13. The picking tool (200, 300) of claim 12, wherein:
the valve plate (210, 310) includes a gasket (212, 312) mounted thereto with which to deformably seal, in use, the pressure port (209, 309).

14. The picking tool (200) of claim 12, wherein:
the valve (208, 308) includes an actuator (221) with which to position the valve plate (210, 310).

15. The picking tool (200, 300) of claim 14, wherein:
the valve (208) includes a further biasing element (226) to bias the valve plate (210) towards the closed position.

16. The picking tool (200, 300) of claim 12, wherein:
the positioner (238, 338) is connected to the valve (208, 308) for coordinated movement, in use, thereof.

17. The picking tool (200) of claim 16, further comprising:
an array of pickers (239), included in which is the picker (240), that are supported on the picker carrier (206) for picking, in use, molded articles, included in which is the molded article (10); and wherein:
the positioner (238) includes a plurality of engagers (231), included in which is the engager (232), each of which is configured to engage, in use, with a subset of the array of pickers (239).

18-20. (canceled)

21. A method (400) of post-mold handling a molded article (10) in an injection molding system (100) having a post-mold retrieval device (122) and a post-mold picking device (132), the method being executable at a controller (103) that is connected to one or more system actuators, the method (400) comprising:
releasing (410) an insertion control signal to cause relative motion between a retrieval tool (127) and a picking tool (200, 300) that are associated with the post-mold retrieval device (122) and the post-mold picking device (132), respectively, whereby a flow director (244, 344) that is associated with a picker (240, 340) on the picking tool (200, 300) is inserted within an interior of the molded article (10) that is being held by a holder (130) that is associated with the retrieval tool (127);
releasing (420) a retraction control signal to cause a positioner (238, 338) that is associated with the picking tool (200, 300) to retract a sealing element (248, 348) that is associated with the picker (240, 340) into a clearance position, whereby a gap is provided between the sealing element (248, 348) and an open end (11) of the molded article (10) through which air is passable;
releasing (430) a conditioning control signal to cause the flow director (244, 344) to promote circulation of air within the interior of the molded article (10);
releasing (440) an extension control signal to cause the positioner (238, 338) to extend, whereby the sealing element (248, 348) becomes extensible towards a picking position for sealably contacting the molded article (10); and
releasing (450) an evacuation control signal to cause an evacuation of air, through the flow director (244, 344), from within the interior of the molded article (10), and responsive thereto cause the molded article (10) to seal with the sealing element (248, 348).

22. The method (400) of claim 21, wherein:
the releasing the retraction control signal to cause the positioner (238, 338) to retract further causes a valve (208, 308) that is associated with the picking tool (200, 300) to connect the flow director (244, 344) with a plenum (129) that is operable to provide a supply of air thereto, whereby a dispensing of air within the interior of the molded article (10) provides for the conditioning thereof.

23. The method (400) of claim 22, wherein:
the releasing (430) the extension control signal to cause the positioner (238, 338) to extend further causes the valve (208, 308) to disconnect the flow director (244, 344) from the plenum (129).
